(19) United States
(12) Patent Application Publication
(10) Pub. No.: US 2007/0137425 A1
(43) Pub. Date: Jun. 21, 2007

(54) Asymmetrical coupling profile between a central axle of a bottom bracket of a bicycle transmission and a pedal crank

(75) Inventors: Giuseppe Dal Pra, Zane (IT); Paolo Dettori, Vicenza (VI) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 11/442,848

(22) Filed: May 30, 2006

(30) Foreign Application Priority Data
May 27, 2005 (EP) 05425376.0

(51) Int. Cl. G05G 1/14

(52) U.S. Cl. 74/594.1

(57) ABSTRACT

A coupling profile is provided having in a plane transversal to an axis (X) of the bottom bracket, outer arcs belonging to the same outer circumference of the coupling, each of such outer arcs being flanked and filleted on one side to a power transmission line and on the opposite side to an idle line. The power transmission line and the idle line are asymmetrical to each other with respect to the outer arc that separates them.

### FIELD OF INVENTION

The present invention deals with the coupling between a central axle of a bottom bracket of a bicycle transmission and a pedal crank. Specifically, the present invention concerns a coupling profile, as well as a central axle and a pedal crank shaped according to said profile.

### BACKGROUND

In relation to a central axle and to a pedal crank of a bicycle transmission, “coupling” means the mutual mechanical interaction between axle and pedal crank that makes the two elements integral in rotation about the axis of the bottom bracket, providing torque or power transmission between the pedal crank and the axle. In the same context, “attachment”, means the mutual mechanical interaction is indicated that makes the two elements integral in translation in the direction of the axis of the bottom bracket, preventing the pedal crank from slipping off, thus ending the coupling.

The coupling between the ends of the central axle and a pedal crank (right or left) of the bicycle is obtained, in a conventional manner, by insertion of the aforementioned ends, projecting outside of a bicycle frame's bottom bracket housing, into suitable receiving seats in ends of the pedal crank's elongated body. Suitable means make the central axle and each of the pedal cranks integral in rotation; an attachment screw then ensures that the coupling between the axle and the pedal crank is maintained.

Herein, “coupling profile” means the ideal outline that separates the body of the central axle from the body of a pedal crank coupled with it. Normally, such a line defines both the outer profile of the axle, and the inner profile of the receiving seat in the pedal crank, apart from the working tolerances; it is nevertheless possible for the aforementioned outer profile of the axle and inner profile of the seat to slightly depart from said an ideal outline, leaving small empty spaces between axle and seat.

The axle-pedal crank coupling must ensure high mechanical strength since during pedaling it is subjected to high and discontinuous stresses, in traction, in bending and in twisting. For such reasons, known axle-pedal crank couplings have been provided with coupling profiles having particular geometric shapes (polygonal or with grooved profiles), providing shape couplings that make the pedal cranks integral in rotation with the central axle.

In such profiles, two or possibly three types of lines are defined that follow each other sequentially:
a power transmission line, which is the line through which the pressing contact between the material of the pedal crank that pushes the material of the axle during pedaling forwards takes place;
an idle line, which is the line through which during pedaling forwards there is contact but not pressing contact, thus without power transmission, since the material of the pedal crank is in front of the material of the axle in the direction of rotation; through this idle line there would be power transmission if backward pedaling were absurdly foreseen, but stresses are in any case also transmitted during certain travel conditions, typically when the cyclist is standing up on the pedals and does not pedal (the cyclist's weight, possibly accentuated by holes or irregularities in the road, weighs down not only on the pedal facing forwards but also on the pedal facing backwards, thus causing a counterthrust on the pedal crank);
possibly, finally, a peripheral line that is formed from an outer circumferential arc of the coupling, or rather of the outer circumference of the axle, and that therefore cannot transmit power either in one direction or the other, since it develops in the same direction as the rotation movement.

Therefore, the coupling profile is formed from a succession along all 360° about the axis of the axle—in the direction of rotation during pedaling forwards—of triads each formed from a power transmission line, a peripheral line (or outer arc of circumference) and an idle line. On the axle and in the receiving seat of the pedal crank this succession determines a corresponding succession of ribs and grooves, extending axially. On the axle, each rib is defined by a power transmission line, an outer arc and an idle line, whereas conversely every groove is defined by an idle line and by a power transmission line. In the seat of the pedal crank, vice-versa, each rib is defined by an idle line and by a power transmission line, whereas conversely every groove is defined by a power transmission line, an outer arc and an idle line.

A conventional type of axle-pedal crank coupling is that known as ISIS standard (see “ISIS Drive—The International Spline Interface Standard, ISIS Drive Standard Committee, 2001), which provides a grooved coupling profile with a defined shape and precise size values for ribs and grooves.

In particular, according to said a standard, the axle has ten equally angularly spaced ribs on its outer surface that extend longitudinally along the axis of the axle, such ribs consisting of crest zones joined by as many depressions having, in section, a circular profile. The fitting between each crest and the adjacent depression consists of a corner having an angle of about 60°, this means that at the fitting point the straight line tangent to the circular depression and the straight line tangent to the crest form an angle of about 60°.

Correspondingly, the pedal crank has a receiving seat with a profile having a shape substantially matching that of the outer profile of the axle and therefore has ten equally angularly spaced grooves that extend longitudinally along the axis of the hole; such grooves consist of corresponding bottom zones joined by as many protrusions projecting towards the axis of the hole, such protrusions having a substantially circular profile in section. The fitting between each bottom and the adjacent protrusion consists of a corner of about 60°.

A problem associated with this type of coupling is a lack of mechanical strength, and this problem is particularly serious since bicycle manufacture requires that the weight of each component is limited.

### SUMMARY

The present invention in particular tackles this problem by an axle-pedal crank coupling in which the mechanical stresses are distributed in a more homogeneous way, with respect to known solutions.

Generally, the present invention deals with, in a first aspect thereof, a coupling profile between a central axle of a bottom bracket of a bicycle transmission and a pedal crank, the coupling profile comprising, in a plane transversal to a central axis of the bottom bracket, outer arcs being flanked and filleted on one side to a power transmission line and on the opposite side to an idle line, wherein the power transmission line and the idle line are symmetrical to each other with respect to the outer arc that separates them.

### BRIEF DESCRIPTION OF THE DRAWINGS

Further characteristics and advantages of the invention shall become clearer from the following description of preferred embodiments thereof, made with reference to the attached drawings, wherein like numerals refer to like elements. In such drawings:

FIG. 1 is an exploded isometric view of a first pedal crank—central axle pair according to the invention;

FIG. 1a is a side view of the pedal crank of FIG. 1;

FIG. 1b is an enlarged view of a detail of FIG. 1a;

FIG. 2 is an exploded isometric view of a second pedal crank—central axle pair according to the invention;

FIG. 3 is a partial view of a coupling profile according to the invention;

FIG. 4 is an overall view of the coupling profile of FIG. 3;

FIG. 5 is a view, similar to FIG. 3, of a variant embodiment of the invention.

### DETAILED DESCRIPTION OF THE PREFERRED EMBODIMENTS

Introduction

In particular, in a first aspect, the invention concerns a coupling profile between a central axle of a bottom bracket of a bicycle transmission and a pedal crank, comprising, in a plane transversal to the axis of the bottom bracket, outer arcs belonging to the same outer circumference of the coupling. Each of said outer arcs being flanked and filleted on one side to a power transmission line and on the opposite side to an idle line, characterized in that the power transmission line and the idle line are asymmetrical with respect to the outer arc that separates them.

Such an asymmetrical configuration allows a more efficient distribution of the stresses transmitted between pedal crank and axle, since it takes into account that the stresses transmitted in the forward pedaling direction are normally greater than those transmitted in the opposite direction.

Preferably, the power transmission line is filleted to the outer arc according to an angle of less than 45°, more preferably less than 20° and even more preferably equal to 0° (tangent fitting). Small angles in this position avoid stress concentration points and consequently structural weakness points on the bottom of the grooves in the seat of the pedal crank.

Preferably, the power transmission line and the idle line comprise portions thereof each filleted tangentially. The tangent fitting where the curvature changes is such as to minimize the concentration of stresses.

The power transmission line and the idle line can have a variously defined curved progression. For the sake of simplicity of construction, the power transmission line comprises a first circumferential arc adjacent to the outer arc, concave towards the axis of the bottom bracket, and a second circumferential arc adjacent to the first circumferential arc, convex towards the axis of the bottom bracket. Preferably, the first circumferential arc and the second circumferential arc of the power transmission line are filleted tangentially according to a straight line that forms an angle of less than 45° with the direction of a radius passing through the point where the first circumferential arc meets the second circumferential arc. An angle of this size ensures that the power transmission line is orientated so as to optimally transmit the power from the pedal crank to the central axle. Again for the sake of simplicity of construction, but also to ensure uniformity in the distribution of stresses, the first concave arc and the second convex arc of the idle line and of the power transmission line have the same radius.

Preferably, in a first variant of the invention, the idle line comprises a radial rectilinear portion, filleted at 90° to the outer arc, and an arc of circumference that is convex towards the axis of the bottom bracket; more preferably, the rectilinear portion and the convex arc are each filleted tangentially. This configuration allows both stress concentration zones to be avoided, and the angular extension of the idle line to be reduced, thus leaving a greater angular extension available for the outer arc and/or for the power transmission line.

In a second variant of the invention, the idle line comprises an arc of circumference that is concave towards the axis of the bottom bracket and an arc of circumference that is convex towards the axis of the bottom bracket; more preferably, the concave arc of circumference and the convex arc of circumference are filleted tangentially Even more preferably, the first portion of the idle line is filleted to the outer arc according to an angle of less than 30°. Thus, a more rounded shape is obtained, which—while having no influence upon the distribution of the stresses—makes it easier to make the coupling profile, above all in the pedal crank, and is less dangerous to handle during assembly and/or maintenance of the pedal cranks.

Preferably, above all for the sake of simplicity of construction—but also for the maximum uniformity in the distribution of the stresses, the convex arc of the idle line and the second convex arc of the adjacent power transmission line are extensions of each other.

In a particularly preferred embodiment, the profile comprises twenty triads each comprising a power transmission line, an outer arc and an idle line, in which the outer arc has an angular extension about the axis of the bottom bracket equal to about 7°, the idle line has an angular extension of about 4° and the power transmission line has an angular extension of about 7°.

In another particularly preferred embodiment, the profile comprises twenty triads each comprising a power transmission line, an outer arc and an idle line, in which the outer arc has an angular extension about the axis of the bottom bracket equal to about 6.5°, the idle line has an angular extension of about 4.5° and the power transmission line has an angular extension of about 7°.

In a second aspect, the invention concerns a central axle of a bottom bracket of a bicycle transmission, comprising two coupling zones for pedal cranks proximate each of its two ends, such zones externally shaped according to a coupling profile in accordance with the first aspect of the invention.

For engagement with an attachment element of the pedal crank, the axle can be hollow and comprise an internal threading at least one or both of its ends, or alternatively it can comprise, at least one or both of its two ends adjacent to the respective coupling zone for the pedal crank, a shank provided with external threading for engagement with an attachment element of the pedal crank. In the first case, the attachment element shall have a substantially screw-type configuration, whereas in the second case it shall have a substantially ring nut-type configuration. Preferably, the axle is made from steel.

In a third aspect, the invention concerns a bicycle pedal crank, comprising a receiving seat for a central axle of a bottom bracket, wherein said seat is shaped according to a coupling profile in accordance with the first aspect of the invention.

Preferably, at least the zone of the pedal crank in which the receiving seat is formed is made from aluminum alloy or other suitable material. The rest of the pedal crank can be either made from the same material, or be made from composite materials, such as carbon fiber and the like.

Description

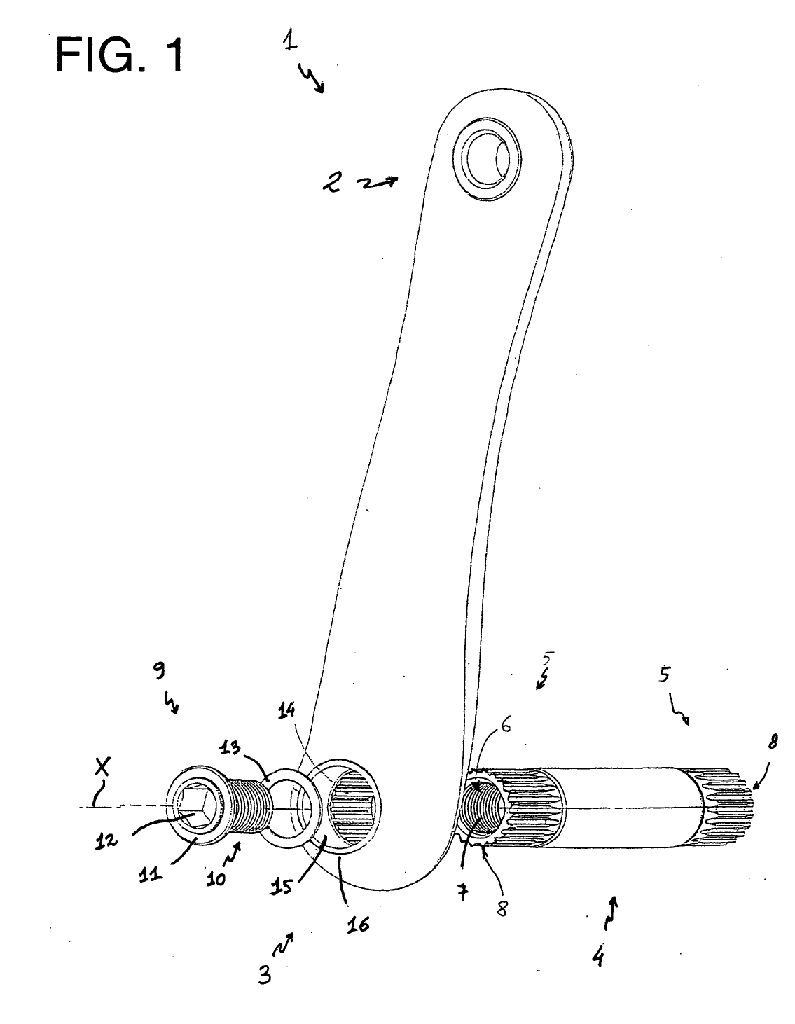

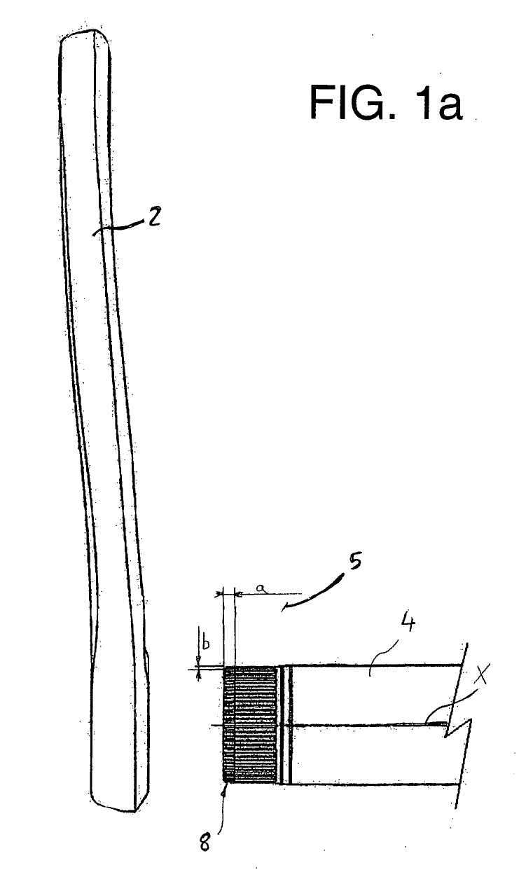

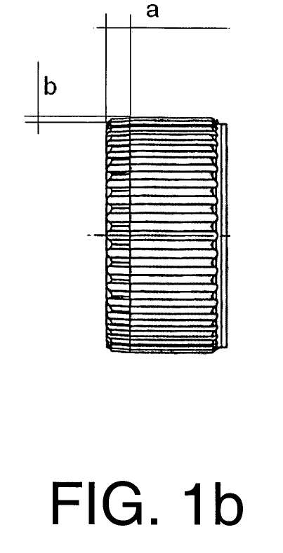

FIG. 1 represents a left pedal crank 1 comprising an elongated body having, at one end, a hole 2 for the attachment of a pedal (not shown) and, at the other end, a receiving seat 3 for a central axle 4. The central axle 4 belongs to the bottom bracket of a bicycle transmission, which is in turn mounted in a suitable housing of the bicycle frame; only the axis X of the bottom bracket is shown in FIG. 1.

If the pedal crank 1 is made entirely of metal, the seat 3 is formed directly in the material that constitutes the pedal crank 1 itself. In a variant embodiment, the pedal crank 1 can be made from composite materials (such as structural fibers incorporated in a matrix of polymeric material, for example carbon fiber in thermo-setting resin) and in such a case the seat 3 can be formed directly in the material that constitutes the pedal crank 1 itself, or else it can be formed on an insert associated with the body of the pedal crank 1, for example a metal or composite material insert, incorporated in the body of the pedal crank 1.

The central axle 4 is hollow and substantially tubular and at its ends it comprises respective coupling zones 5 with the left pedal crank 1 and with the right pedal crank (not shown).

Each coupling zone 5 of the central axle 4 is provided with a central opening 6 with internal threading 7 for engagement with an attachment element of the pedal crank 1, such as an attachment screw 9.

The attachment screw 9 comprises a threaded shank 10, a flanged head 11 and a hexagonal recess 12 for engagement with a suitable tool (not illustrated).

The seat 3 of the pedal crank 1 comprises a first coupling zone 14 coupleable to coupling zone 5 of the central axle 4 and a second zone 15, adjacent to the first coupling zone 14 and with a greater diameter than it. Between the two zones 14 and 15 an annular abutment surface 16 is defined. A lock washer 13 is arranged between the head 11 of the screw 9 and the annular abutment surface 16 in the seat 3 of the pedal crank 1.

When the pedal crank 1 is assembled to the central axle 4, the internal threading 7 of the coupling zone 5 of the central axle 4 is in engagement with the threaded shank 10 of the screw 9. The head 11 of the attachment screw 9 is arranged completely inside the second zone 15; said zone can then possibly be closed by a lid, not shown in the illustrated example.

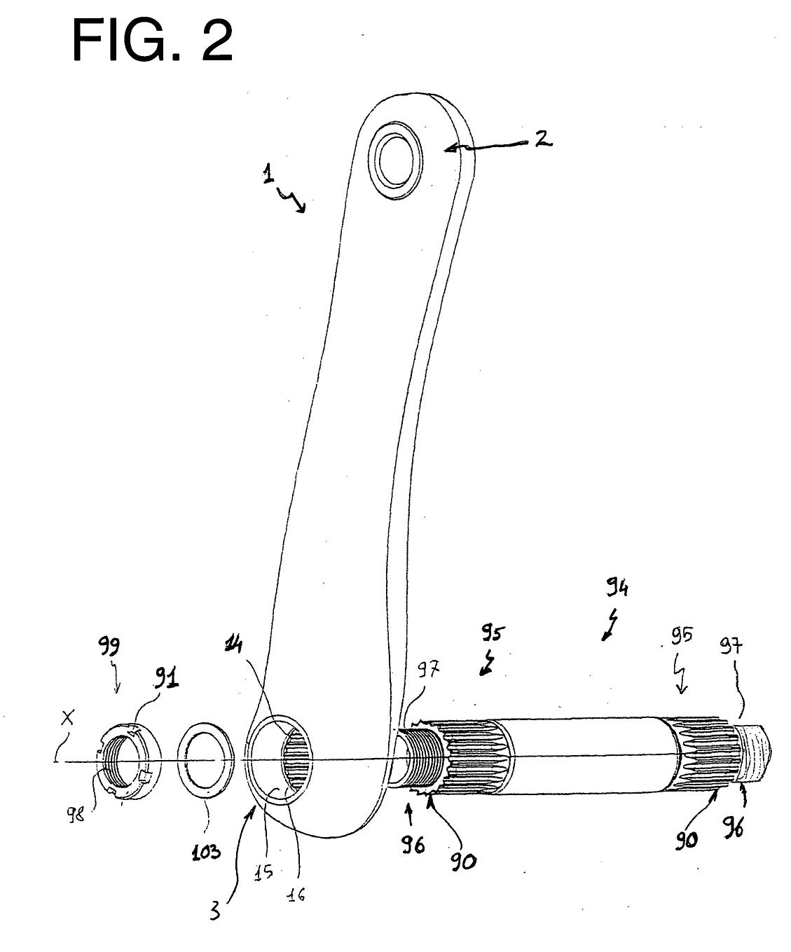

FIG. 2 illustrates a pedal crank 1 (identical to FIG. 1, and therefore numbered in the same way) and a central axle 94. The axle 94, proximate each end, comprises two respective coupling zones 95 with the left pedal crank 1 and with the right pedal crank (the latter of which is not shown), and two respective cylindrical shanks 96, projecting axially with respect to the zones 95. The shanks 96 are provided with external threading 97 for engagement with an attachment element of the pedal crank, such as an attachment ring nut 99. The attachment ring nut 99 consists of an annular element provided with internal threading 98 that engages on the external threading 97 of the shank 96 of the central axle 94 and with outer notches 91 for engagement by a tool (not illustrated). As in the embodiment of FIG. 1, an anti-friction washer 103 is arranged between the ring nut 99 and the annular abutment surface 16 in the seat 3 of the pedal crank 1.

When the pedal crank 1 is assembled to the central axle 94, the external threading 97 of the cylindrical shank 96 of the central axle 94 is engageable with the internal threading 98 of the attachment ring nut 99. The ring nut 99 is arranged completely inside the second zone 15 of the seat 3; as in the embodiment of FIG. 1, said zone can then be closed by a lid, not shown.

In a variant of the invention, to lock the pedal cranks, the central axle can be provided on one side with an internal threading (such as threading 7 of the axle 4 of FIG. 1) and on the other side with a threaded shank (such as shank 96 of axle 94 of FIG. 2).

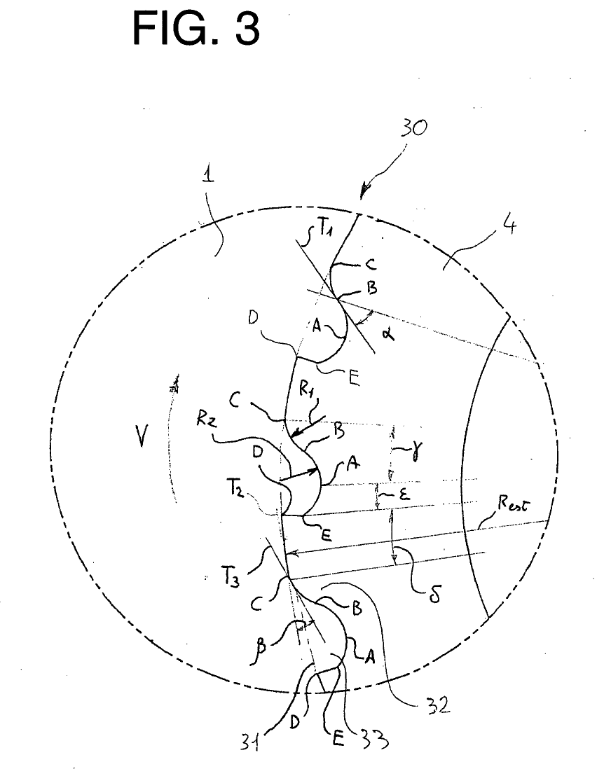

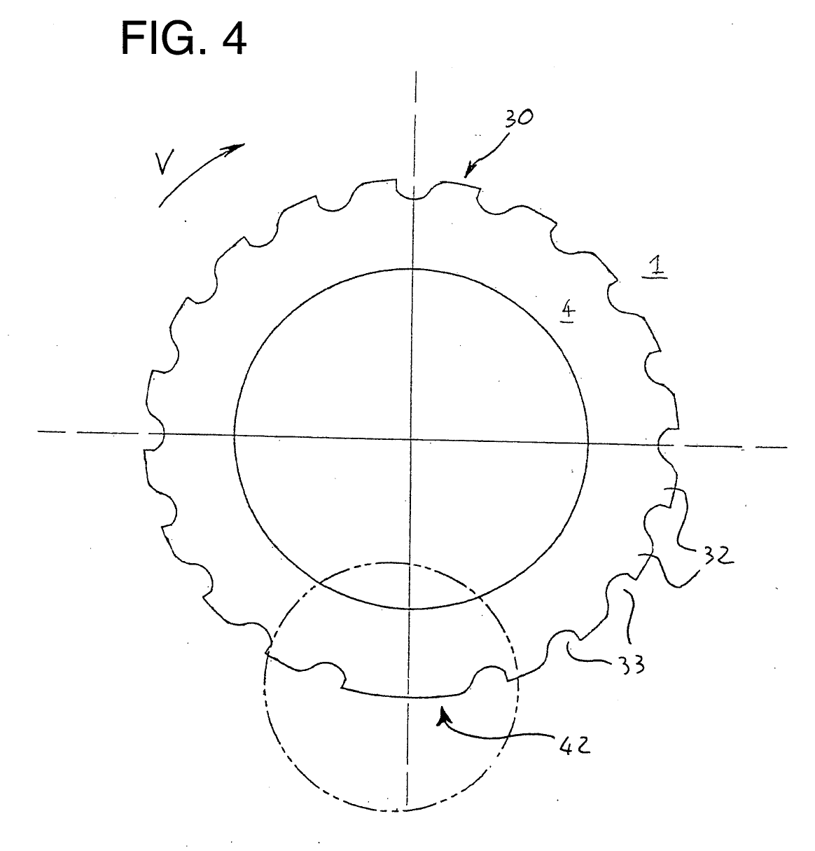

FIG. 3 illustrates an enlarged view of a portion of a coupling profile 30 according to the invention, wholly illustrated in FIG. 4. It should be understood that the coupling profile 30 extends with regularity 360° about the axis X of the bottom bracket, possibly with a discontinuity 42 having a key assembly function; as shown in FIG. 4, said discontinuity 42 is, for example, provided by the lack of a groove 33, the two adjacent ribs 32 being joined together. For greater clarity, in FIGS. 3 and 4 the direction of rotation of the pedal crank 1 during forward pedaling is indicated by V. Again for the sake of clarity, the zones around the coupling profile 30 are respectively numbered 1 and 4 to indicate the arrangement of pedal crank and axle; however, it is clear—as already explained—that the illustrated coupling profile 30 is an ideal outline, and that the actual outer profile of the axle 4 and inner profile of the seat 3 of the pedal crank 1 can possibly depart from said ideal outline.

The coupling profile 30 comprises a periodically repeated succession (excluding discontinuity 42) about the axis X of three close lines that are filleted adjacent each other, indicated hereafter and in the figures by the respective end points: a power transmission line AC, an outer arc CD and an idle line DA.

The power transmission line AC comprises a first portion of line BC formed from a circumferential arc of circumference having radius R1, convex towards the axis X, and a second portion of line AB formed from a circumferential arc having radius R2, concave towards the axis X. The two portions AB and BC are filleted adjacent each other tangentially, i.e. in point B the tangent to the portion AB coincides with the tangent to the portion BC; said tangent T1 is inclined with respect to the radial direction R by an angle α equal to about 30°. Preferably, the radii R1 and R2 are the same.

The outer arc CD comprises a portion of an outer circumference 31 of the coupling profile 30, and therefore has radius Rest. The outer arc CD is filleted to the power transmission line AC in point C according to an angle β (defined between the respective tangents T2 and T3 in which T2 is the tangent of the outer arc CD and T3 is the tangent of the portion BC of the power transmission line) of less than 45°, preferably less than 20°, and more preferably substantially equal to 0°. In the illustrated example, β is not set to zero, in order to be able to highlight it better; indeed, in said example the arcs AC and CD are filleted adjacent each other substantially tangentially.

The idle line DA comprises a first portion of line DE formed from a rectilinear portion, extending in the radial direction and thus filleted at 90° to the outer arc CD, and from a second portion of line EA formed from a circumferential arc having radius R1 (equal to the radius of the first portion of line AB), which is convex towards axis X. The two portions DE and EA are filleted adjacent each other according to an angle of about 45°. The fitting with sharp edge at 90° in point D of the profile 30 does not prejudice its strength, because in that zone during forward pedaling there is no transmission of stresses between pedal crank 1 and central axle 4.

The portion of line EA and the portion of line AB are not only filleted adjacent each other tangentially, but are more precisely extensions of each other, i.e. they are portions of the same circumferential arc having radius R1. Preferably, R1 is equal to the distance in the radial direction of point A from outer circumference 31.

Each power transmission line AC has an extension in the angular direction about axis X equal to an angle γ, each outer arc CD has an extension in the angular direction about axis X equal to an angle δ and each idle line DA has an extension in the angular direction about axis X equal to an angle ε.

As an example, the illustrated profile 30 provides twenty ribs 32 and the values of δ, δ and ε are respectively equal to about 7.5°, 6.5° and 4°.

The triad of lines AB, BD and DA as stated is repeated along the 360° about the axis X and therefore the coupling profile 30 defines a succession of filleted loops, which can be considered from the point of view of the axle 4 or from that of the pedal crank 1. By adopting the point of view of the axle 4 (which may be more instinctive looking at FIG. 3) the aforementioned loops thus comprise ribs 32 and grooves 33. The number of ribs 32 and therefore of grooves 33 can be chosen by the designer of the transmission; the greater the number, the lesser the extension in the angular or circumferential direction of the ribs 32 and grooves 33.

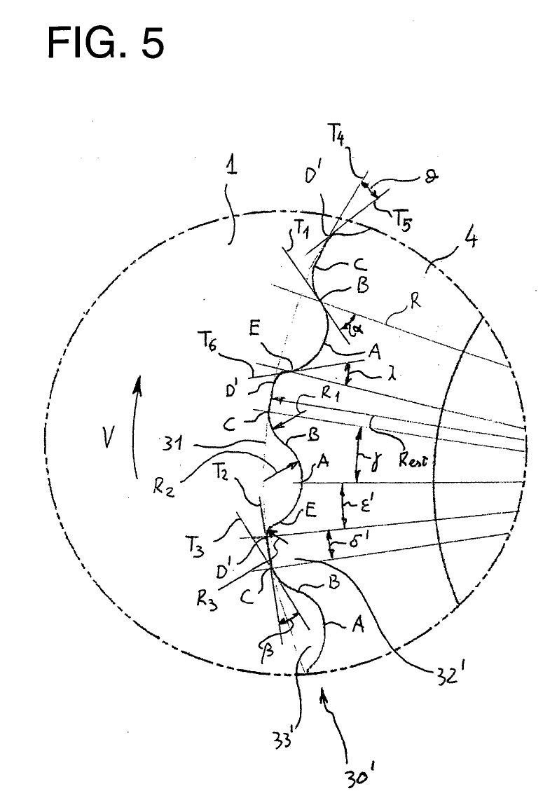

In FIG. 5, in the same way as FIG. 3, a portion of a coupling profile 30′ according to a variant of the invention is illustrated on an enlarged scale. The profile 30′ is partially equal to the profile 30; therefore, for the details and elements of the profile 30′ that correspond to details or elements of the profile 30, the same reference numerals as the profile 30 are used, with the addition of an apostrophe in the cases in which the detail or element is different in the profile 30′ with respect to the profile 30.

The fundamental difference between profile 30′ and profile 30 is in point D′, which separates the outer arc CD′ from the first portion of the idle line D′E. At said point D′ the first portion D′E of the idle line and the outer arc CD′ converge; at point D′, the outer arc CD′ has the tangent T4, whereas the first portion of the idle line D′E has the tangent T5, and between T4 and T5 a fitting angle [symbol] substantially less than 90° is defined, preferably less than 30°.

The first portion D′E of the idle line is therefore not radial, but rather is formed from a circumferential arc that is concave towards axis X and having radius R3, filleted tangentially to the portion EA in point E according to a straight line T6, inclined with respect to the radial direction by an angle λ of less than 45°, preferably equal to about 30°. Preferably, radius R3 is different from radii R1 and R2, more preferably less than them.

As a result, the angles δ′ and ε′ that express the angular size of the outer arc CD′ and of the idle line D′A change with respect to the profile 30: δ′ is smaller than δ, whereas ε′ is greater than ε. On the other hand, the angle γ that expresses the angular size of the power transmission line AC remains unchanged.

As an example, the illustrated profile 30′ foresees twenty ribs 32′ and the values of γ, δ′ and ε′ are respectively equal to about 7.5°, 6° and 4.5°. It should be noted that in FIG. 5 both radii R1, R2 and R3, and angles γ, δ′ and ε′ are represented purely qualitatively and not quantitatively for reasons of clarity of drawing; in particular, radius R3 has intentionally been exaggerated to allow it to be seen, with the consequence that the angle δ′ appears in the figures to be greater than ε′, whereas the opposite is true.

Profile 30′, with respect to profile 30, behaves in a mechanically analogous way, since it has the same power transmission line AC. Nevertheless, it may be preferred for simplicity of construction, since the 90° edge may be difficult to make. Moreover, the axle 4 made according to profile 30′ lacks sharp edges, and therefore is safer to handle during assembly and/or maintenance of the pedal cranks.

The coupling zones 5 of the axle 4 and the coupling zones 95 of the axle 94 are preferably provided with a respective beveled insertion portion 8 and 90, proximate the respective end of the axle. Characteristic features of the insertion portions 8 and 90 are an axial extension a, and a diameter reduction b (FIGS. 1a and 1b); the diameter reduction b is intended as the difference between a diameter measured at the side of the insertion portion 8 or 90 close to the main portion of the coupling zone 5 or 95 and the same diameter measured at the other side of the insertion portion 8 or 90, proximate the end of the axle 4 or 94 and remote from the main portion of the coupling zone 5 or 95. Preferably, the axial extension a is at least 3 times the diameter reduction b, and at most 10 times the diameter reduction.

The diameter reduction b can be the same whether calculated in respect of the outer circumference 31 of the coupling profile 30, 30′ or in respect of any other characteristic point of the coupling profile 30, 30′, such as points A or B. This means that the whole coupling profile 30, 30′ is beveled in the same way. Alternatively, in order to make manufacturing easier and cheaper, the diameter reduction b can be provided only in respect of the outer circumference 31 of the coupling profile 30, 30′; this option is particularly preferred when the ratio between the axial extension a and the diameter reduction b is high, i.e. where the diameter reduction b is small relative to the axial extension a.

Thanks to the insertion portions 8, 90, insertion of the axle 4, 94 into the seat 3 of the pedal crank 1 is made easier and more precise. The beveled insertion portions 8, 90 guide the axle 4, 94 during insertion into the seat 3 and avoid damage to the coupling profile 30, 30′ of the axle 4, 94 and of the seat 3 during insertion.

A coupling profile according to the invention, having no sharp edge zones on the power transmission line, allows a homogeneous distribution of stresses both in the pedal crank and in the central axle; moreover, the asymmetric shape of the profile, with the power transmission line different to the idle line, allows the mechanical characteristics of the material to be better exploited according to the essentially asymmetrical stresses transmitted during forward pedaling.

Consequently, this coupling profile allows the weight of the transmission to be reduced without reducing its strength or increasing the risks of breaking, i.e. it allows strength to be increased without increasing weight.

1. Coupling profile between a central axle of a bottom bracket of a bicycle transmission and a pedal crank, the coupling profile comprising, in a plane transversal to an axis (X) of the bottom bracket, outer arcs belonging to the same outer circumference of the coupling, each of such outer arcs being flanked and filleted on one side to a power transmission line and on the opposite side to an idle line, wherein the power transmission line and the idle line are asymmetrical to each other with respect to the outer arc that separates them.

2. Profile according to claim 1, wherein the power transmission line comprises portions all filleted adjacent each other tangentially.

3. Profile according to claim 1, wherein the power transmission line is filleted to the outer arc at an angle of less than 45°.

4. Profile according to claim 1, wherein the power transmission line is filleted to the outer arc at an angle of less than 20°.

5. Profile according to claim 1, wherein the power transmission line is filleted tangentially to the outer arc.

6. Profile according to claim 1, wherein the power transmission line comprises a first circumferential arc adjacent to the outer arc, which is concave towards central axis (X) of the bottom bracket, and a second arc of circumference adjacent to the first arc of circumference, which is convex towards central axis (X) of the bottom bracket.

7. Profile according to claim 6, wherein the first circumferential arc and the second circumferential arc are filleted tangentially according to a straight line that forms an angle less than 45° with the direction of a radius passing through the point where the first circumferential arc meets the second circumferential arc.

8. Profile according to claim 6, wherein the first concave arc and the second convex arc of the power transmission line have the same radius.

9. Profile according to claim 1, wherein the idle line comprises a radial rectilinear portion, filleted at 90° to the outer arc, and a circumferential arc that is convex towards the central axis (X) of the bottom bracket.

10. Profile according to claim 9, wherein the rectilinear portion and the circumferential arc are filleted at an angle of about 45°.

11. Profile according to claim 1, wherein the idle line comprises a circumferential arc that is concave towards the axis (X) of the bottom bracket and a circumferential arc that is convex towards the axis (X) of the bottom bracket.

12. Profile according to claim 11, wherein the concave circumferential arc and the convex circumferential arc are filleted tangentially.

13. Profile according to claim 11, wherein the first portion of the idle line is filleted to the outer arc at an angle of less than 30°.

14. Profile according to claim 6, wherein the idle line comprises a radial rectilinear portion, filleted at 90° to the outer arc, and a circumferential arc that is convex towards the central axis (X) of the bottom bracket, wherein the convex arc of the idle line and the second convex arc of the adjacent power transmission line are extensions of each other.

15. Profile according to claim 9, wherein the power transmission line comprises a first circumferential arc adjacent to the outer arc, which is concave towards central axis (X) of the bottom bracket, and a second arc of circumference adjacent to the first arc of circumference which is convex towards central axis (X) of the bottom bracket and wherein the convex arc of the idle line and the second convex arc of the adjacent power transmission line are extensions of each other.

16. Profile according to claim 6, wherein the idle line (D′A) comprises a circumferential arc that is concave towards the axis (X) of the bottom bracket and a circumferential arc that is convex towards the axis (X) of the bottom bracket, wherein the convex arc of the idle line and the second convex arc of the adjacent power transmission line are extensions of each other.

17. Profile according to claim 11, wherein the power transmission line comprises a first circumferential arc adjacent to the outer arc, which is concave towards central axis (X) of the bottom bracket, and a second arc of circumference adjacent to the first arc of circumference, which is convex towards central axis (X) of the bottom bracket and wherein the convex arc of the idle line and the second convex arc of the adjacent power transmission line are extensions of each other.

18. Profile according to claim 1, comprising twenty triads each comprising a power transmission line, an outer arc and an idle line, wherein the outer arc has an angular extension about the axis (X) of the bottom bracket of about 6.5°, the idle line has an angular extension of about 4° and the power transmission line has an angular extension of about 7.5°.

19. Profile according to claim 1, comprising twenty triads each comprising a power transmission line, an outer arc and an idle line, wherein the outer arc has an angular extension about the axis (X) of the bottom bracket of about 6°, the idle line has an angular extension of about 4.5° and the power transmission line has an angular extension of about 7.5°.

20. Central axle of a bottom bracket of a bicycle transmission, comprising two coupling zones that are engagable with pedal cranks, wherein such zones are shaped according to the coupling profile of claim 1.

21. Axle according to claim 20, wherein the axle is hollow and comprises an internal threading at least one of its ends, for engagement with an attachment element of the pedal crank.

22. Axle according to claim 20, comprising, at least one of its two ends and adjacent to the respective coupling zone for the pedal crank, a shank having external threading for engagement with an attachment element of the pedal crank.

23. Axle according to claim 20, wherein it is made from steel.

24. Axle according to claim 20, wherein the coupling zones include a bevelled insertion portion proximate the respective end of the axle.

25. Axle according to claim 20, wherein the bevelled insertion portions have an axial extension and a diameter reduction, the axial extension being 3 to 10 times the reduction of diameter.

26. Axle according to claim 25, wherein the diameter reduction is the same whether calculated in respect of the outer circumference or with respect of any other characteristic point of the coupling profile.

27. Axle according to claim 25, wherein the diameter reduction is provided only in respect of the outer circumference of the coupling profile.

28. Pedal crank of a bicycle transmission, comprising a coupling seat for a central axle of a bottom bracket, wherein said seat is shaped according to a coupling profile of claim 1.

29. Pedal crank of a bicycle transmission, comprising a coupling seat for a central axle of a bottom bracket, wherein said seat is shaped according to a coupling profile of claim 1, wherein at least the zone in which the receiving seat is formed is made from aluminum alloy.

30. Central axle of a bottom bracket of a bicycle transmission, comprising two coupling zones engagable with pedal cranks proximate each of the two ends thereof, wherein the coupling zones include a bevelled insertion portion proximate the respective end of the axle.

31. Axle according to claim 30, wherein the bevelled insertion portions have an axial extension and a diameter reduction, the axial extension being 3 to 10 times the reduction of diameter.

32. Axle according to claim 30, wherein the diameter reduction is the same whether calculated in respect of an outer circumference of the coupling profile or with respect of any other characteristic point of the coupling profile.

33. Axle according to claim 30, wherein the diameter reduction is provided only in respect of an outer circumference of the coupling profile.
